(19) United States
(12) Patent Application Publication
(10) Pub. No.: US 2024/0107532 A1
(43) Pub. Date: Mar. 28, 2024

(54) METHODS, DEVICES, AND SYSTEMS FOR CONFIGURING AND TRANSMITTING SCHEDULING REQUEST

(71) Applicant: ZTE Corporation, Shenzhen (CN)

(72) Inventors: Wei GOU, Shenzhen (CN); Junfeng ZHANG, Shenzhen (CN); Shuaihua KOU, Shenzhen (CN); Xianghui HAN, Shenzhen (CN)

(73) Assignee: ZTE Corporation, Shenzhen (CN)

(21) Appl. No.: 18/534,242

(22) Filed: Dec. 8, 2023

Related U.S. Application Data
(63) Continuation of application No. PCT/CN2022/087987, filed on Apr. 20, 2022.

(51) Int. Cl. H04W 72/1268; H04W 72/21

(52) U.S. Cl. CPC H04W 72/1268; H04W 72/21

(57) ABSTRACT

The present disclosure describes methods, system, and devices for configuring and transmitting a scheduling request (SR). One method includes determining, by a user equipment (UE) configured with a primary cell (PCell) and a secondary cell (SCell), a first scheduling request (SR) in the PCell, a first logical channel identifier (ID) being associated with the first SR configured in the PCell; and determining, by the UE, a second SR in the SCell. Another method includes configuring, by a base station, a UE with a PCell and a SCell, wherein: a first SR is configured in the PCell, a first logical channel ID being associated with the first SR configured in the PCell; and/or a second SR is configured in the SCell.

### TECHNICAL FIELD

The present disclosure is directed generally to wireless communications. Particularly, the present disclosure relates to methods, devices, and systems for configuring and transmitting a scheduling request (SR).

### BACKGROUND

Wireless communication technologies are moving the world toward an increasingly connected and networked society. High-speed and low-latency wireless communications rely on efficient network resource management and allocation between user equipment and wireless access network nodes (including but not limited to base stations). A new generation network is expected to provide high speed, low latency and ultra-reliable communication capabilities and fulfill the requirements from different industries and users.

A scheduling request (SR) is configured for a user equipment (UE) in a cell, based on SR configuration information. The SR configuration information may include an initial slot of the SR and a period of the SR. The SR configuration information may also include a PUCCH resource (SR PUCCH) for transmitting the SR. In this way, a series of slots for transmitting the SR PUCCH may be determined based on the SR configuration information. when the UE has an SR request to send (i.e., the SR is positive), the UE may transmit the SR PUCCH in the determined slots. When the UE has an SR request to send (i.e., the SR is positive), the UE may not transmit the SR PUCCH in the determined slots.

### SUMMARY

This document relates to methods, systems, and devices for wireless communication, and more specifically, for configuring and transmitting a scheduling request (SR). The various embodiments in the present disclosure may include new SR configuration and transmission method, which is beneficial to improve the joint operation of SR physical uplink control channel (PUCCH) transmission and PUCCH cell switching, to increase the resource utilization efficiency, and to boost latency performance of the wireless communication, including but not limited to, ultra-reliable low latency communication (URLLC).

In one embodiment, the present disclosure describes a method for wireless communication. The method includes determining, by a user equipment (UE) configured with a primary cell (PCell) and a secondary cell (SCell), a first scheduling request (SR) in the PCell, a first logical channel identifier (ID) being associated with the first SR configured in the PCell; and determining, by the UE, a second SR in the SCell.

In one embodiment, the present disclosure describes a method for wireless communication. The method includes configuring, by a base station, a user equipment (UE) with a primary cell (PCell) and a secondary cell (SCell), wherein: a first scheduling request (SR) is configured in the PCell, a first logical channel identifier (ID) being associated with the first SR configured in the PCell; and/or a second SR is configured in the SCell.

In some other embodiments, an apparatus for wireless communication may include a memory storing instructions and a processing circuitry in communication with the memory. When the processing circuitry executes the instructions, the processing circuitry is configured to carry out the above methods.

In some other embodiments, a device for wireless communication may include a memory storing instructions and a processing circuitry in communication with the memory. When the processing circuitry executes the instructions, the processing circuitry is configured to carry out the above methods.

In some other embodiments, a computer-readable medium comprising instructions which, when executed by a computer, cause the computer to carry out the above methods.

The above and other aspects and their implementations are described in greater detail in the drawings, the descriptions, and the claims.

### BRIEF DESCRIPTION OF THE DRAWINGS

FIG. 1 shows an example of a wireless communication system include one wireless network node and one or more user equipment.

FIG. 2 shows an example of a network node.

FIG. 3 shows an example of a user equipment.

FIG. 4A shows a flow diagram of a method for wireless communication.

FIG. 4B shows a flow diagram of another method for wireless communication.

FIG. 5 shows a schematic diagram of an exemplary embodiment for wireless communication.

FIG. 6 shows a schematic diagram of another exemplary embodiment for wireless communication.

FIG. 7 shows a schematic diagram of another exemplary embodiment for wireless communication.

### DETAILED DESCRIPTION

The present disclosure will now be described in detail hereinafter with reference to the accompanied drawings, which form a part of the present disclosure, and which show, by way of illustration, specific examples of embodiments. Please note that the present disclosure may, however, be embodied in a variety of different forms and, therefore, the covered or claimed subject matter is intended to be construed as not being limited to any of the embodiments to be set forth below.

Throughout the specification and claims, terms may have nuanced meanings suggested or implied in context beyond an explicitly stated meaning. Likewise, the phrase “in one embodiment” or “in some embodiments” as used herein does not necessarily refer to the same embodiment and the phrase “in another embodiment” or “in other embodiments” as used herein does not necessarily refer to a different embodiment. The phrase “in one implementation” or “in some implementations” as used herein does not necessarily refer to the same implementation and the phrase “in another implementation” or “in other implementations” as used herein does not necessarily refer to a different implementation. It is intended, for example, that claimed subject matter includes combinations of exemplary embodiments or implementations in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” or “at least one” as used herein, depending at least in part upon context, may be used to describe any feature, structure, or characteristic in a singular sense or may be used to describe combinations of features, structures or characteristics in a plural sense. Similarly, terms, such as “a”, “an”, or “the”, again, may be understood to convey a singular usage or to convey a plural usage, depending at least in part upon context. In addition, the term “based on” or “determined by” may be understood as not necessarily intended to convey an exclusive set of factors and may, instead, allow for existence of additional factors not necessarily expressly described, again, depending at least in part on context.

The present disclosure describes methods and devices for configuring and transmitting a scheduling request (SR).

New generation (NG) mobile communication system are moving the world toward an increasingly connected and networked society. High-speed and low-latency wireless communications rely on efficient network resource management and allocation between user equipment and wireless access network nodes (including but not limited to wireless base stations). A new generation network is expected to provide high speed, low latency and ultra-reliable communication capabilities and fulfil the requirements from different industries and users.

A scheduling request (SR) is configured for a cell including one or more user equipment (UE), based on SR configuration information. The SR configuration information may include an initial slot of the SR and a period of the SR. The SR configuration information may also include a PUCCH resource (SR PUCCH) for transmitting the SR. In this way, a series of slots for transmitting the SR PUCCH may be determined based on the SR configuration information. when the UE has an SR request to send (i.e., the SR is positive), the UE may transmit the SR PUCCH in the determined slots. When the UE has an SR request to send (i.e., the SR is positive), the UE may not transmit the SR PUCCH in the determined slots.

In some implementations, for a cell, the PUCCH resource of the SR may be configured with a repetition factor N (N is a positive integer). When the N corresponding to an SR PUCCH is greater than 1, and when the SR is positive, for a first SR PUCCH transmission, the UE may determine a slot based on the SR configuration information, and then sends the SR PUCCH in the corresponding slot. For one or more remaining (N-1) SR PUCCH transmissions in the cell, the corresponding slots may be determined, by the UE, from the cell according to the following conditions.

One condition for the slot may be that an uplink symbol (UL symbol) or a flexible symbol (F symbol) is provided in the slot, and the uplink symbol or the flexible symbol has a same index as the first symbol of the first SR PUCCH transmission of the SR, for example, the index being the symbol index in the slot.

Another condition for the slot may be that consecutive UL/F symbols may be provided in the slot, and an index of the starting symbol of the consecutive UL/F symbols is the same as an index of the first symbol of the first SR PUCCH transmission, and the number of consecutive UL/F symbols is greater than or equal to the number of symbols for the first SR PUCCH transmission.

In some implementations, when the slot satisfies the above two conditions, the slot is determined as the slot for transmitting the SR PUCCH, and the remaining SR PUCCH is transmitted in the slot by using the same SR PUCCH resources as the first SR PUCCH transmission.

In some implementations, a PUCCH cell switching may be supported. For example, the UE is configured with a primary cell (PCell) and a secondary cell (SCell), and the UE is configured to transmit a HARQ-ACK PUCCH between the PCell and the SCell based on a predefined PUCCH slot pattern between the PCell and the SCell. This mechanism may be referred as semi-static PUCCH cell switching.

In some implementations, a dynamic PUCCH cell switching mechanism may be supported. For example, a downlink control information (DCI) may be used to instruct a cell from a PCell and a SCell in order to transmit a HARQ-ACK PUCCH. In some implementations, when a DCI schedules a physical downlink shared channel (PDSCH), the DCI may also indicate a cell from the PCell and the SCell to transmit the HARQ-ACK PUCCH corresponding to the PDSCH. This mechanism may allow the HARQ-ACK PUCCH to be transmitted as early as possible in the case where the uplink (UL) slots of the PCell and the UL slots of the SCell are complementary, for example but not limited, when both the PCell and the SCell are cells in a time division duplex (TDD) mode.

The present disclosure describes various embodiments of methods to support the joint operation of the SR transmission and the PUCCH cell switching.

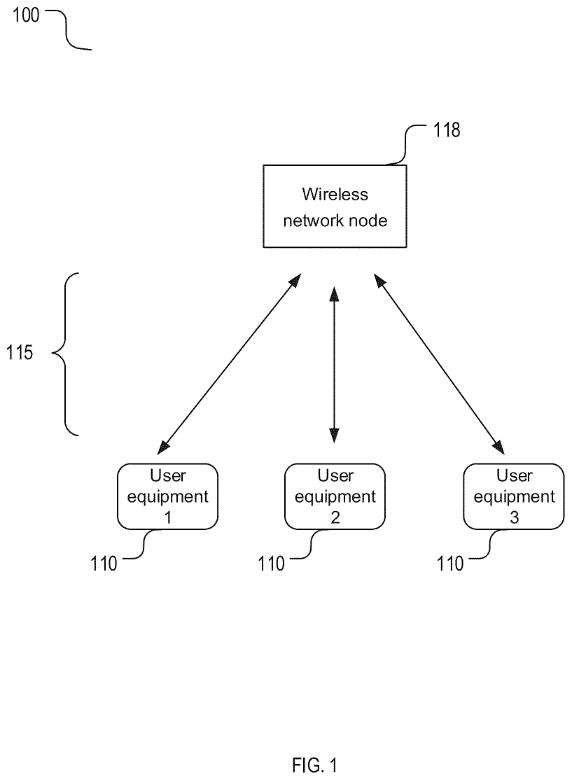

FIG. 1 shows a wireless communication system 100 including a wireless network node 118 and one or more user equipment (UE) 110. The wireless network node may include a network base station, which may be a nodeB (NB, e.g., a gNB) in a mobile telecommunications context. Each of the UE may wirelessly communicate with the wireless network node via one or more radio channels 115 for downlink/uplink communication. For example, a first UE 110 may wirelessly communicate with a wireless network node 118 via a channel including a plurality of radio channels during a certain period of time. The network base station 118 may send high layer signaling to the UE 110. The high layer signaling may include configuration information for communication between the UE and the base station. In one implementation, the high layer signaling may include a radio resource control (RRC) message.

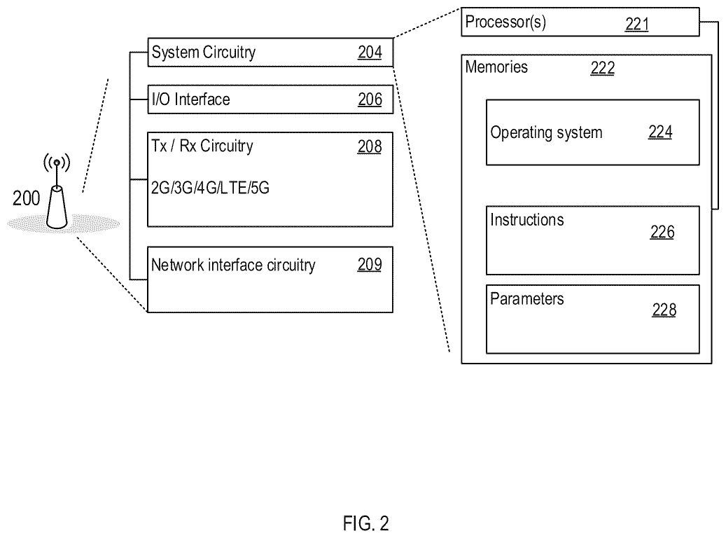

FIG. 2 shows an example of electronic device 200 to implement a network base station. The example electronic device 200 may include radio transmitting/receiving (Tx/Rx) circuitry 208 to transmit/receive communication with UEs and/or other base stations. The electronic device 200 may also include network interface circuitry 209 to communicate the base station with other base stations and/or a core network, e.g., optical or wireline interconnects, Ethernet, and/or other data transmission mediums/protocols. The electronic device 200 may optionally include an input/output (I/O) interface 206 to communicate with an operator or the like.

The electronic device 200 may also include system circuitry 204. System circuitry 204 may include processor(s) 221 and/or memory 222. Memory 222 may include an operating system 224, instructions 226, and parameters 228. Instructions 226 may be configured for the one or more of the processors 124 to perform the functions of the network node. The parameters 228 may include parameters to support execution of the instructions 226. For example, parameters may include network protocol settings, bandwidth parameters, radio frequency mapping assignments, and/or other parameters.

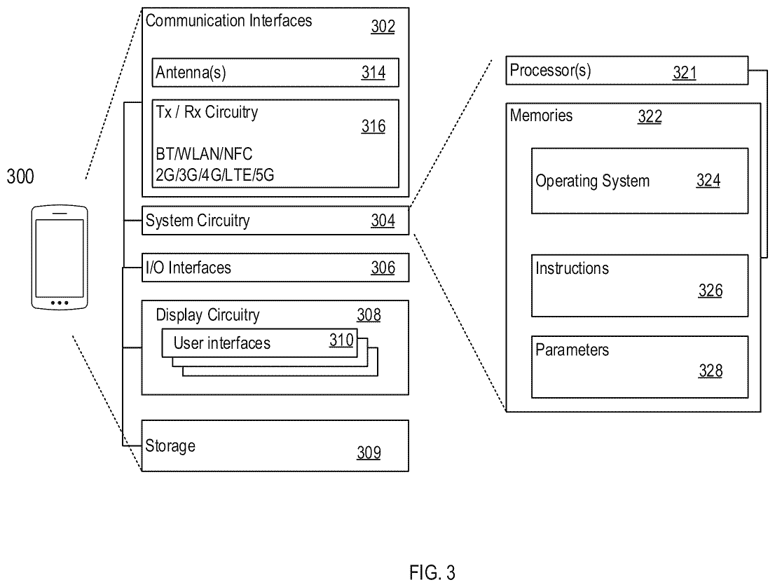

FIG. 3 shows an example of an electronic device to implement a terminal device 300 (for example, user equipment (UE)). The UE 300 may be a mobile device, for example, a smart phone or a mobile communication module disposed in a vehicle. The UE 300 may include communication interfaces 302, a system circuitry 304, an input/output interfaces (I/O) 306, a display circuitry 308, and a storage 309. The display circuitry may include a user interface 310. The system circuitry 304 may include any combination of hardware, software, firmware, or other logic/circuitry. The system circuitry 304 may be implemented, for example, with one or more systems on a chip (SoC), application specific integrated circuits (ASIC), discrete analog and digital circuits, and other circuitry. The system circuitry 304 may be a part of the implementation of any desired functionality in the UE 300. In that regard, the system circuitry 304 may include logic that facilitates, as examples, decoding and playing music and video, e.g., MP3, MP4, MPEG, AVI, FLAC, AC3, or WAV decoding and playback; running applications; accepting user inputs; saving and retrieving application data; establishing, maintaining, and terminating cellular phone calls or data connections for, as one example, internet connectivity; establishing, maintaining, and terminating wireless network connections, Bluetooth connections, or other connections; and displaying relevant information on the user interface 310. The user interface 310 and the inputs/output (I/O) interfaces 306 may include a graphical user interface, touch sensitive display, haptic feedback or other haptic output, voice or facial recognition inputs, buttons, switches, speakers and other user interface elements. Additional examples of the I/0 interfaces 306 may include microphones, video and still image cameras, temperature sensors, vibration sensors, rotation and orientation sensors, headset and microphone input/output jacks, Universal Serial Bus (USB) connectors, memory card slots, radiation sensors (e.g., IR sensors), and other types of inputs.

Referring to FIG. 3, the communication interfaces 302 may include a Radio Frequency (RF) transmit (Tx) and receive (Rx) circuitry 316 which handles transmission and reception of signals through one or more antennas 314. The communication interface 302 may include one or more transceivers. The transceivers may be wireless transceivers that include modulation/demodulation circuitry, digital to analog converters (DACs), shaping tables, analog to digital converters (ADCs), filters, waveform shapers, filters, pre-amplifiers, power amplifiers and/or other logic for transmitting and receiving through one or more antennas, or (for some devices) through a physical (e.g., wireline) medium. The transmitted and received signals may adhere to any of a diverse array of formats, protocols, modulations (e.g., QPSK, 16-QAM, 64-QAM, or 256-QAM), frequency channels, bit rates, and encodings. As one specific example, the communication interfaces 302 may include transceivers that support transmission and reception under the 2G, 3G, BT, WiFi, Universal Mobile Telecommunications System (UMTS), High Speed Packet Access (HSPA)+, 4G/Long Term Evolution (LTE), 5G standards, and/or 6G standards. The techniques described below, however, are applicable to other wireless communications technologies whether arising from the 3rd Generation Partnership Project (3GPP), GSM Association, 3GPP2, IEEE, or other partnerships or standards bodies.

Referring to FIG. 3, the system circuitry 304 may include one or more processors 321 and memories 322. The memory 322 stores, for example, an operating system 324, instructions 326, and parameters 328. The processor 321 is configured to execute the instructions 326 to carry out desired functionality for the UE 300. The parameters 328 may provide and specify configuration and operating options for the instructions 326. The memory 322 may also store any BT, WiFi, 3G, 4G, 5G, 6G, or other data that the UE 300 will send, or has received, through the communication interfaces 302. In various implementations, a system power for the UE 300 may be supplied by a power storage device, such as a battery or a transformer.

The present disclosure describes various embodiment for configuring and transmitting a scheduling request (SR), which may be implemented, partly or totally, on the network base station and/or the user equipment described above in FIGS. 2-3. The various embodiments in the present disclosure may enable the joint operation of SR physical uplink control channel (PUCCH) transmission and PUCCH cell switching, which may increase the resource utilization efficiency and/or boost latency performance of wireless communication.

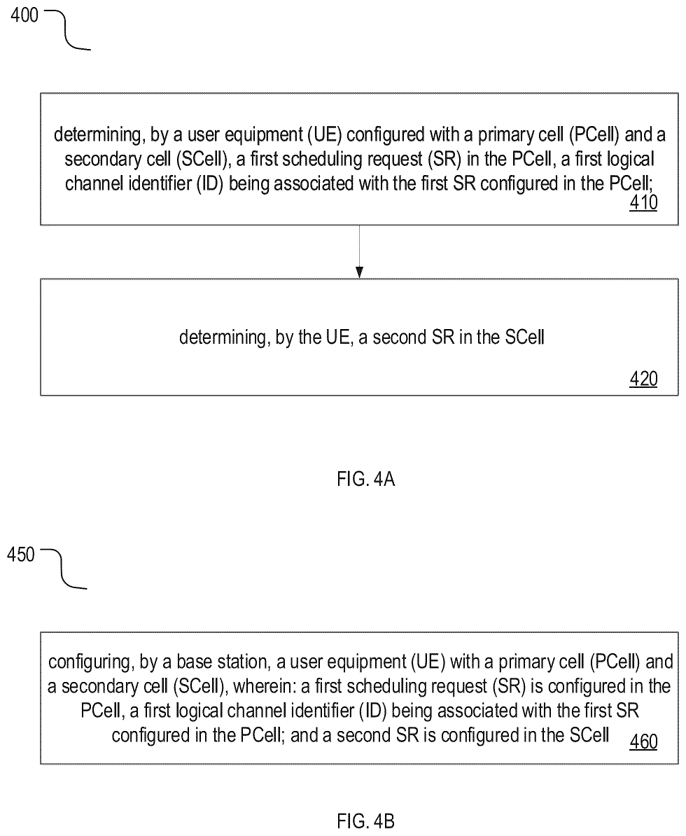

Referring to FIG. 4A, the present disclosure describes various embodiments of a method 400 for wireless communication. The method may include a portion or all of the following steps: step 410, determining, by a user equipment (UE) configured with a primary cell (PCell) and a secondary cell (SCell), a first scheduling request (SR) in the PCell, a first logical channel identifier (ID) being associated with the first SR configured in the PCell; and/or step 420, determining, by the UE, a second SR in the SCell.

Referring to FIG. 4B, the present disclosure describes various embodiments of a method 450 for wireless communication. The method may include a portion or all of the following steps: step 460, configuring, by a base station, a user equipment (UE) with a primary cell (PCell) and a secondary cell (SCell), wherein: a first scheduling request (SR) is configured in the PCell, a first logical channel identifier (ID) being associated with the first SR configured in the PCell; and/or a second SR is configured in the SCell.

In some implementations, the method 400 or 450 may further include determining, by the UE, a second logical channel ID associated with the second SR configured in the SCell to be same as the first logical channel ID associated with the first SR configured in the PCell.

In some implementations, a physical uplink control channel (PUCCH) for transmitting a SR (SR PUCCH) is configured with a repetition factor N, N being a positive integer; and/or in response to the repetition factor N being larger than one, the UE perform PUCCH cell switching between the PCell and the SCell for determining a slot to transmit a next SR PUCCH repetition based on a PUCCH slot pattern by: in response to the first logical channel ID being associated with a SR configured in a next earliest PUCCH slot indicated by the PUCCH slot pattern, the next earliest PUCCH slot is selected to transmit the next SR PUCCH repetition.

In some implementations, in response to a SR PUCCH being triggered by the first logical channel ID, the UE perform PUCCH cell switching between the PCell and the SCell for determining a slot to transmit the SR PUCCH based on a PUCCH slot pattern by: in response to the first logical channel ID being associated with a SR configured in a next earliest PUCCH slot indicated by the PUCCH slot pattern, the next earliest PUCCH slot is selected to transmit the SR PUCCH.

In some implementations, in response to a next PUCCH slot in the PCell overlapping in a time domain with a next PUCCH slot in the SCell, the next PUCCH slot in the PCell is selected to transmit the next SR PUCCH repetition.

In some implementations, a SR PUCCH is configured with a repetition factor N, N being a positive integer; and in response to the repetition factor N being larger than one, the UE perform PUCCH cell switching between the PCell and the SCell for determining a slot to transmit a next SR PUCCH repetition according to at least one of the following: a PUCCH slot pattern configured between the PCell and SCell, a PUCCH format of a first SR PUCCH repetition, a number of symbols of a first SR PUCCH repetition, an index of a first symbol of a first SR PUCCH repetition, a period position of SR occasions, or a logical channel ID associated with a SR.

In some implementations, the UE determines the slot to transmit the next SR PUCCH repetition according to the PUCCH slot pattern configured between the PCell and SCell, the period position of SR occasions, and the logical channel ID associated with the SR.

In some implementations, the UE determines the PUCCH slot to transmit the next SR PUCCH repetition according to the PUCCH slot pattern configured between the PCell and SCell and the logical channel ID associated with the SR.

In some implementations, the UE determines the slot to transmit the next SR PUCCH repetition according to the PUCCH slot pattern configured between the PCell and SCell, the number of symbols of the first SR PUCCH repetition, and the index of the first symbol of the first SR PUCCH repetition.

In some implementations, a first periodic position of the first SR is configured in a PCell slot; a second periodic position of the second SR is configured in a SCell slot; and/or the PCell slot and the SCell slot do not overlap in a time domain.

In some implementations, a first period of the first SR is same as a second period of the second SR; and/or a first offset of the first SR is different as a second offset of the second SR.

In some implementations, a first periodic position of the first SR is configured in a PCell slot; a second periodic position of the second SR is configured in a SCell slot; the PCell slot and the SCell slot overlap in a time domain; and/or in response to a SR PUCCH in one of the PCell slot and the SCell slot being invalid or in response to an uplink control information (UCI) multiplexing being performed in one of the PCell slot and the SCell slot and a resulting multiplexing PUCCH including the SR being invalid, one of the following is performed: not indicating the one of the PCell slot and the SCell slot as a PUCCH slot, indicating the other of the PCell slot and the SCell slot as a PUCCH slot, or defaulting the other of the PCell slot and the SCell slot as a PUCCH slot, wherein the SR PUCCH is transmitted in the PUCCH slot.

In some implementations, a SR PUCCH is configured with a repetition factor N, N being a positive integer; and/or in response to the repetition factor N being larger than one, the UE determines a slot to transmit a next SR PUCCH repetition according to at least one of the following: determining a slot based on the PUCCH slot pattern to transmit the next SR PUCCH repetition, or determining the other of the PCell slot and the SCell slot to transmit the next SR PUCCH repetition.

In some implementations, a first periodic position of the first SR is configured in a PCell slot; a second periodic position of the second SR is configured in a SCell slot; the PCell slot and the SCell slot overlap in a time domain; in response to a SR PUCCH in both of the PCell slot and the SCell slot being valid, one of the following is performed: indicating one of the PCell slot and the SCell slot as a PUCCH slot, or defaulting one of the PCell slot and the SCell slot as a PUCCH slot; and/or in response to an UCI multiplexing being performed in one of the PCell slot and the SCell slot and a resulting multiplexing PUCCH including the SR being valid, one of the following is performed: indicating the one of the PCell slot and the SCell slot as a PUCCH slot, or defaulting the one of the PCell slot and the SCell slot as a PUCCH slot.

In some implementations, a SR PUCCH is configured with a repetition factor N, N being a positive integer; and/or in response to the repetition factor N being larger than one, the UE determines a slot to transmit a next SR PUCCH repetition according to at least one of the following: determining a slot based on the PUCCH slot pattern to transmit the next SR PUCCH repetition, or determining the one of the PCell slot and the SCell slot to transmit the next SR PUCCH repetition.

In some implementations, a first periodic position of the first SR is configured in a PCell slot; a second periodic position of the second SR is configured in a SCell slot; the PCell slot and the SCell slot overlap in a time domain; in response to a SR PUCCH in both of the PCell slot and the SCell slot being valid and being associated with a same logical channel ID, one of the following is performed: indicating one of the PCell slot and the SCell slot as a PUCCH slot, or defaulting one of the PCell slot and the SCell slot as a PUCCH slot; and/or in response to the SR in both of the PCell slot and the SCell slot being associated with a same logical channel ID, and an UCI multiplexing being performed in one of the PCell slot and the SCell slot and a resulting multiplexing PUCCH including the SR being valid, one of the following is performed: indicating the one of the PCell slot and the SCell slot as a PUCCH slot, or defaulting the one of the PCell slot and the SCell slot as a PUCCH slot.

In some implementations, a SR PUCCH is configured with a repetition factor N, N being a positive integer; and/or in response to the repetition factor N being larger than one, the UE determines a slot to transmit a next SR PUCCH repetition according to at least one of the following: determining a slot based on the PUCCH slot pattern to transmit the next SR PUCCH repetition, or determining the one of the PCell slot and the SCell slot to transmit the next SR PUCCH repetition.

The present disclosure describes various embodiments for supporting the joint operation of SR PUCCH with repetition factor greater than 1 and PUCCH cell switching. The various embodiments may include the following implementations, which may transmit SR as early as possible in a TDD system.

In some implementations, a UE may be configured with a PCell and a SCell. The UE is configured with SR in the SCell and the PCell respectively; and the UE is configured with PUCCH resources in PCell and SCell respectively. The UE is configured to perform PUCCH cell switching between the PCell and the SCell based on the configured PUCCH slot pattern between the PCell and the SCell; or the UE is configured to perform PUCCH cell switching between the PCell and the SCell based on DCI indication.

In some implementations, for SR configuration in SCell, a SR configuration rule may include a portion or all of the following. A logical channel ID associated with the SR configured in the SCell may be the same as the logical channel ID associated with the SR configured in the PCell. That is, when an SR is configured in the PCell, and when the logical channel ID associated with the SR is n, the logical channel ID associated with the SR configured in the SCell is also n. That is, multiple SRs in different cell may be configured to be associated with one logical channel ID. Once there is a scheduling request on logical channel n (representing a logical channel whose logical channel ID is n), the UE may select an earliest SR period position to transmit SR based on the SR configuration in the PCell and the SCell, minimizing the SR delay.

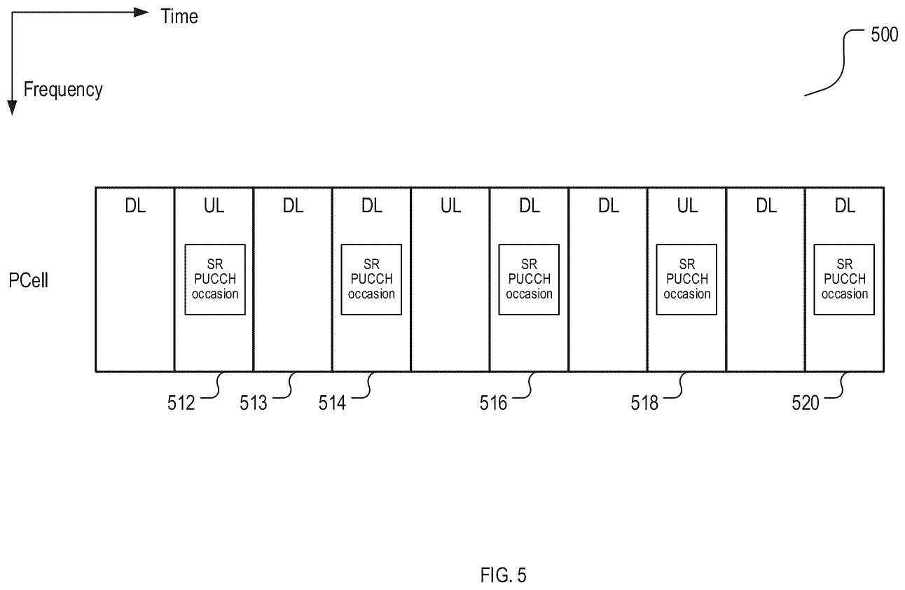

In some implementations, FIG. 5 shows an SR configuration 500. For example, the PCell is a TDD cell. The period of the configured SR is 2 slots and the starting slot of the configured SR is slot 2 (512), and thus, the SR PUCCH occasions are configured in slot 2 (512), slot 4 (514), slot 6 (516), slot 8 (518), and slot 10 (520). In some implementations, the SR may be only allowed to be configured in the PCell, and the SR may be not allowed to be configured in the SCell. When the UE has an SR request in the third slot (513) in FIG. 5, the UE may have to wait until the eighth slot (518) to transmit the SR PUCCH, due to the reason that the SR PUCCH may not be transmitted on the 4th slot (514) or the 6th slot (516) because they are downlink slots.

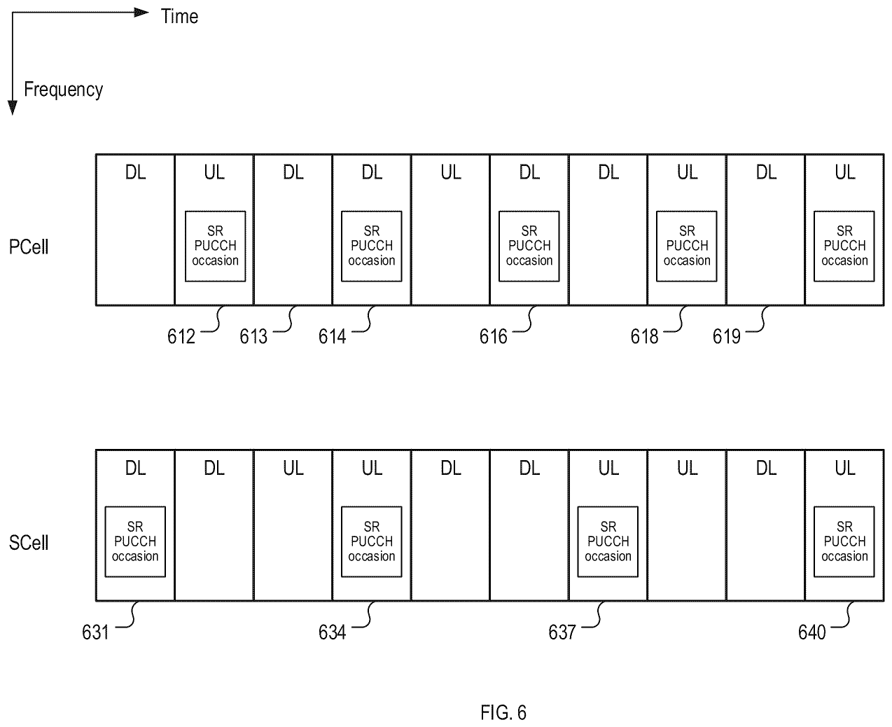

In some implementations, FIG. 6 shows another non-limiting example of each SR configured in a PCell and a SCell. In the PCell, the period of the configured SR is 2slots and the starting slot of the configured SR is slot 2 (612); and in the SCell, the configured SR has a period of 3 slots and has a starting slot of slot 1 (631).

In some implementations, the following rule may be followed for configuring the SR in the SCell. The logical channel ID associated with the SR configured in the SCell may be configured the same as the logical channel ID associated with the SR in the PCell. For example, an SR is configured in PCell, it is configured to associate with logical channel n, and its period position is shown in FIG. 6. An SR is also configured in the SCell, which is also configured to associate with the logical channel n, and its period position is shown in FIG. 6.

In some implementations, when the logical channel n has a transmission request in the 3rd slot of the PCell (613), the UE may transmit the SR PUCCH in the 4th slot of the SCell (634) because the SR in the SCell is configured with the associated logical channel ID is also n. The slot 614 or 616 may not be selected for transmitting the SR PUCCH because the slot 614 or 616 is a downlink slot. The slot 634 is selected for transmitting the SR PUCCH because the slot 634 is an uplink slot with SR PUCCH occasion, and/or because the slot 634 is the earliest slot available for transmitting the SR PUCCH. The slot 637 or 618 may not be selected for transmitting the SR PUCCH because the slot 637 or 618 is later than the slot 634.

In some implementations, the logical channel IDs to which the SRs configured in PCell and SCell are associated may be different, for example, the SR configured in the PCell is associated with the logical channel n, and the SR configured in the SCell is associated with the logical channel n+1. Under the circumstances, when the logical channel n has a transmission request in the 3rd slot of the PCell (613), the UE may not transmit the SR PUCCH in the 4th slot of the SCell (634), because, although an SR period is configured in the fourth slot of the SCell (634), the logical channel ID corresponding to the SR is n+1 rather than n.

In some implementations, the SRs in the PCell and the SCell may be configured to associate with a same logical channel ID, and the SR period positions are shown in FIG. 6. When the same logical channel ID triggers the scheduling request in the 9th slot of the PCell (619), the UE may determine how to transmit the SR PUCCH in the 10th slot from either the 10th slot of the PCell (620) or the 10th slot of the SCell (640). The UE may use at least of the following methods to determine which slot to use for transmitting the SR PUCCH in the 10th slot. Method 1, the UE may respectively transmit the SR corresponding to the logical channel ID in the PCell and the SCell. Method 2, the UE may arbitrarily select a Cell from the PCell and the SCell for transmitting the SR corresponding to the logical channel ID. Method 3, the SR corresponding to the logical channel ID may be transmitted in the PCell by default. Method 4, the SR corresponding to the logical channel ID may be transmitted in the SCell by default. Method 5, when the SR in one cell is cancelled due to overlapping with the downlink symbol or SSB symbol or core resource set (CORESET, e.g., CORESET#0) symbol or high priority channel, the UE may transmit the SR corresponding to the logical channel ID in another cell. Method 6, the UE may transmit the SR corresponding to the logical channel ID in the configured or indicated PUCCH cell. Here, the PUCCH cell may be configured or indicated from either the PCell or the SCell.

In some implementations, Methods 3, 4, 5, and 6 may be more conducive to reducing the complexity of base station reception. In Methods 3, 4, 5, and 6, the SR may be transmitted only in one cell determined from the PCell and the SCell, the base station may not need to try to blindly receive in two cells, thus, reducing the reception complexity of the base station.

In some implementations, based on the SR configuration, for an SR PUCCH with a repetition factor greater than 1, each SR PUCCH repetition may be in either the PCell or the SCell.

In some implementations, for an SR PUCCH with a repetition factor greater than 1 configured in the PCell and the SCell, the SR PUCCH resource in the SCell may have the same format and/or number of symbols as the SR PUCCH resource in the PCell.

In some implementations, for a logical channel n associated with SRs in the PCell and the SCell respectively, when the SR PUCCHs of the SRs are configured with a repetition factor greater than 1, and when one SR PUCCH repetition of the SR is transmitted in the PCell (or the Scell), the next SR PUCCH repetition of the SR may be transmitted in the SCell (or the PCell). Here, the next SR PUCCH repetition of the SR may be transmitted in the slot where the period position of another SR associated with the logical channel n is located.

Optionally and/or alternatively, in various embodiments, a UE is configured with a PCell and a SCell; the UE is configured with a SR in the SCell; and/or the UE is configured with PUCCH resources in the PCell and the SCell respectively.

In some implementations, the UE may be configured to perform PUCCH cell switching between the PCell and the SCell based on the configured PUCCH slot pattern between the PCell and the SCell; or the UE may be configured to perform PUCCH cell switching between the PCell and the SCell based on DCI indication.

In some implementations, a SR PUCCH with repetition factor greater than 1 may be transmitted by the UE. The first SR PUCCH repetition of the SR may be transmitted in slot n in the PCell (or SCell), and the UE may determine the slot and SR PUCCH resource for the remaining SR PUCCH repetitions according to at least one of the following factors: the PUCCH slot pattern configured between the PCell and the SCell, the PUCCH format of the first SR PUCCH repetition, the number of symbols of the first SR PUCCH repetition, the index of the first symbol of the first SR PUCCH repetition, the period position of SR, and/or the logical channel ID.

In some implementations, the PUCCH slot pattern may be used to determine a set of slots, and may be used to select one or more slots from the set of slots based on other factors.

In some implementations, the PUCCH format may be used to select a PUCCH resource in the selected slot, for example, being used to select the PUCCH resource with the same format as the PUCCH corresponding to the first SR PUCCH repetition.

In some implementations, the number of symbols of the first SR PUCCH repetition and the index of the first symbol of the first SR PUCCH repetition may be used to select the slot and determine the PUCCH resource in the selected slot. For example, the PUCCH resource with the same number of symbols as the PUCCH corresponding to the first SR PUCCH repetition may be selected. For another example, the factors may be used to select the PUCCH resource with the same first symbol index of the PUCCH corresponding to the first SR PUCCH repetition. For another example, the factors may be used to select the slot that can provide the requested PUCCH resource described above.

In some implementations, the logical channel ID may be used to select SR and/or SR PUCCH resources. For example, the logical channel ID may be used to select the SR with the same logical channel ID as the first SR PUCCH repetition. For another example, the logical channel ID may be used to select the SR PUCCH resource corresponding to the selected SR.

In some implementations, the period position of SR may be used to select the slot. For example, the period position of SR may be used to select the slot where the period position of the selected SR is located.

In some implementations, after slot n, the UE may select the slots that satisfy the above one or more conditions from the slots of the PCell and/or the SCell. In the selected slot, a PUCCH resource is determined as the PUCCH for transmitting the remaining SR PUCCH repetitions.

The present disclosure describes some specific non-limiting examples of selecting slots in the following paragraphs.

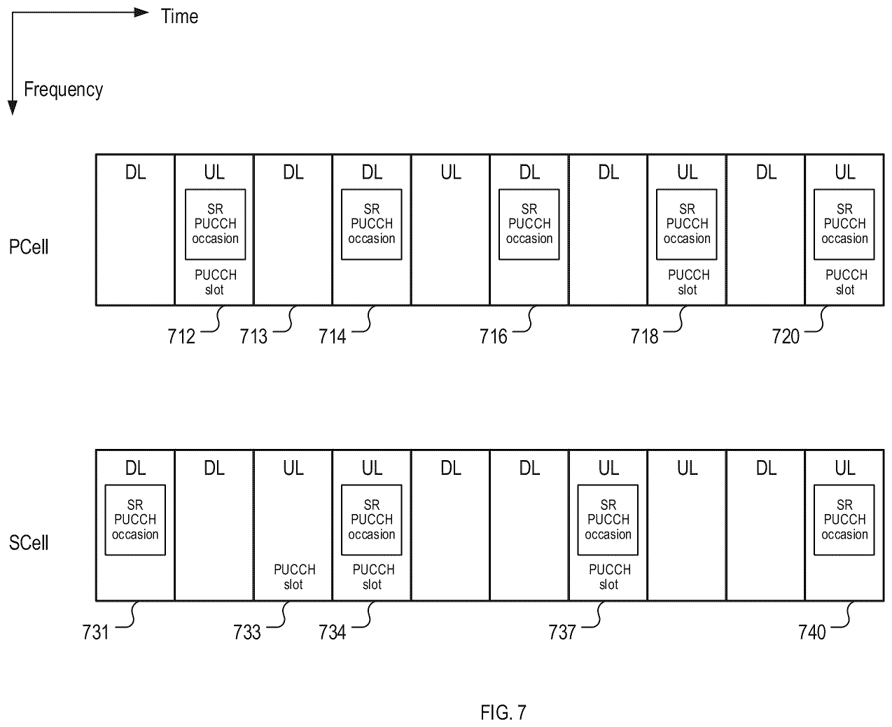

For one non-limiting exemplary example, referring to FIG. 7, SRs are configured in both the PCell and the SCell, and they are associated with the same logical channel ID k, and their period/starting positions are shown in FIG. 7. The PUCCH slots are also configured in the PCell and the SCell as shown in FIG. 7. In the PCell, the SR PUCCH occasions may be scheduled in a second slot (712), a fourth slot (714), a sixth slot (716), an eighth slot (718), and a tenth slot (720). In the SCell, the SR PUCCH occasions may be scheduled in a first slot (731), a fourth slot (734), a seventh slot (737), and a tenth slot (740).

In some implementations, in the PCell, the repetition factor of the SR PUCCH of the SR is 2. When the logical channel k triggers a SR transmission, and when the first SR PUCCH repetition of the SR is in the second slot in the PCell (712), the UE may determine where is the second SR PUCCH repetition of the SR and/or which PUCCH resource is used.

In some implementations, a slot may be selected as the second PUCCH repetition based on the period position of SR, the PUCCH slot pattern, and the logical channel ID. Specifically, after the slot where the first PUCCH repetition is located, when a slot is a PUCCH slot, is a slot where the period position of an SR is located, and is a slot wherein the SR is associated with the logical channel k, the slot is selected. In this way, the selected slot is the 4th slot of the SCell (734). In this way, the UE sends the second PUCCH repetition in the fourth slot of the SCell by using the SR PUCCH resource of the SR configured in the SCell.

In some implementations, a slot may be selected as the second PUCCH repetition based on a PUCCH slot pattern and a logical channel ID. Specifically, after the slot where the first PUCCH repetition is located, when a slot is a PUCCH slot, when the cell where the slot is located is configured with an SR, and when the SR is associated with the logical channel k, the slot is selected. In this way, the selected slot is the 3th slot of the SCell (733). In this way, the UE sends the second PUCCH repetition in the 3th slot of the SCell by using the SR PUCCH resource of the SR associated with the logical channel k in the SCell.

For another non-limiting exemplary example, referring to FIG. 7, SRs are configured in both the PCell and the SCell, they are associated with the same logical channel k, and their period positions/starting slots are shown in FIG. 7. The PUCCH slots are also configured in the PCell and the SCell as shown in FIG. 7.

In some implementations, in PCell, the repetition factor of the SR PUCCH of the SR is 2. When a logical channel k triggers SR transmission, and when the first SR PUCCH repetition of the SR is in the second slot in the PCell, the UE may determine where is the second SR PUCCH repetition of the SR and/or which PUCCH resource is used.

In some implementations, the UE may select a slot for the second PUCCH repetition based on the PUCCH slot pattern, the number of symbols of the first SR PUCCH repetition, and the index of the first symbol of the first SR PUCCH repetition. Specifically, after the slot where the first PUCCH repetition is located, when a slot is a PUCCH slot, can provide the same number of symbols as the first PUCCH repetition, and can provide the same index of the first symbol as the first PUCCH repetition, the slot is selected. In the selected slot, according to the number of symbols of the first SR PUCCH repetition and the index of the first symbol of the first SR PUCCH repetition, the UE may select a PUCCH resource for the second PUCCH repetition from the cell where the selected slot is located. In some implementations, the selected slot may be the third slot of the SCell (733). The UE selects a PUCCH resource from the Cell where the selected slot is located. For example, the selected PUCCH resource has the same number of symbols as the first PUCCH repetition, and has the same index of the first symbol as the first PUCCH repetition, then the slot is selected. And UE sends the second PUCCH repetition in the selected PUCCH resource in the third slot of the SCell.

In some implementations, the UE may select a slot for the second PUCCH repetition based on the PUCCH slot pattern and the number of symbols of the first SR PUCCH repetition. Specifically, after the slot where the first PUCCH repetition is located, when a slot is a PUCCH slot and can provide the same number of symbols as the first PUCCH repetition, the slot is selected. In the selected slot, according to the number of symbols of the first SR PUCCH repetition, the UE may select a PUCCH resource for the second PUCCH repetition from the cell where the selected slot is located. In some implementations, the selected slot may be the third slot of the SCell (733). The UE selects a PUCCH resource from the Cell where the selected slot is located. For example, when the selected PUCCH resource has the same number of symbols as the first PUCCH repetition, the slot is selected. The UE sends the second PUCCH repetition in the selected PUCCH resource in the third slot of the SCell. The SRs configured in the PCell and the SCell may be associated with the same logical channel ID, and the SR PUCCH resources of the SRs associated with the same logical channel ID in the PCell and the SCell may be configured with the same number of symbols.

In some implementations, it may not be mandatory to configure SR in the SCell. When SRs are configured in the SCell, the operation of selecting a slot may be the same as the method described above, and selecting a PUCCH resource for the second PUCCH repetition may also be done in the following way: the UE may select a PUCCH resource from the set of PUCCH resources configured for SRs, and the selected PUCCH resource has the same number of symbols as the first PUCCH repetition, and has the same index of the first symbol as the first PUCCH repetition.

The present disclosure describes various embodiments for supporting the joint operation of SR PUCCH and PUCCH cell switching. The various embodiments may include the following implementations, wherein when a base station wants to configure SRs in a PCell and a SCell configured to a UE, the SR configuration may adopt at least one of the following rules. In some implementation, these rules may be applicable when the UE is configured with dynamic PUCCH cell switching. By configuring SRs in the PCell and the SCell, the transmission of SR PUCCH may be achieved by the UE as early as possible in the PCell or the SCell in a TDD mode, thus avoiding the delay of SR.

For Rule 1, when the base station configures the SR for the UE in the PCell and the periodic position of the SR is in PCell slot n, and when the base station configures the SR for the UE in the SCell and the periodic position of the SR is in the SCell slot m, the base station may ensure that the PCell slot n does not overlap with SCell slot m in the time domain. That is to say, when the SRs are configured in both the PCell and the SCell, the slot where the SR in the PCell is located does not overlap with the slot where the SR in the SCell is located in the time domain.

In some implementations, the SR in PCell slot n and the SR in SCell slot m may be associated with the same or different logical channel IDs.

In some implementations, when the UE is configured with SR in the PCell and the periodic position of the SR is configured in the PCell slot n, and when the UE is configured with SR in the SCell and the periodic position of the SR is configured in the SCell slot m, the UE may expect that the PCell slot n does not overlap with the SCell slot m in the time domain. That is, when the SRs are configured in the PCell and the SCell for the UE, the UE may not expect that the slot where the SR in the PCell is located overlaps with the slot where the SR in the SCell is located in the time domain. Here and in various embodiments/implementations in the present disclosure, m and n are natural numbers or non-negative integers, for example, 0, 1, 2, 3, and etc.

In some implementations, the SR in the PCell slot n and the SR in SCell slot m may be associated with the same or different logical channel IDs.

In some implementations, for SR configuration, a SR may be configured in the PCell first. The SR may be configured in the SCell. In other words, once an SR in the PCell slot n is configured, when another SR is configured in an SCell, the slot of the configured SR in the SCell may not overlap with PCell slot n.

In some implementations, when the PCell slot n and the SCell slot m are both uplink slots and overlap in the time domain, Rule 1 may ensure that only one SR is configured for transmission, in order to reduce the base station blindly receiving SRs from the PCell and the SCell.

For Rule 2, the base station configures the SR in the PCell for the UE, and configures the periodic position of the SR in the PCell slot n. The base station configures the SR in the SCell for the UE, and configures the periodic position of the SR in the SCell slot m. When the slot n and the slot m are overlapping in the time domain, and when the PUCCH of the SR configured in the slot n (or slot m) is invalid or when the UCI multiplexing is performed in the slot n (or slot m), the multiplexing result PUCCH is invalid, the base station may: indicate the slot m (or slot n) as a PUCCH slot; or default the slot m (or slot n) as a PUCCH slot; not indicate the slot n (or slot m) as a PUCCH slot; or expect a SR PUCCH to be transmitted in the slot m (or slot n) when there is a positive SR.

In some implementations, the base station may expect the SR PUCCH to be transmitted in the PUCCH slot if there is a positive SR. In some implementations, the SR in the PCell slot n and the SR in the SCell slot m may be associated with the same or different logical channel IDs.

In some implementations, the UE is configured with an SR in the PCell and the periodic position of the SR is configured in the PCell slot n. The UE is configured with another SR in the SCell and the periodic position of this SR is configured in the SCell slot m. When the slot n and the slot m are overlapping in the time domain, and when the PUCCH of the SR configured in the slot n (or slot m) is invalid or when UCI multiplexing is performed in the slot n (or slot m), the multiplexing result PUCCH is invalid, then UE may expect the slot m (or slot n) to be indicated as a PUCCH slot; or expect the slot m (or slot n) to be defaulted to a PUCCH slot; or does not expect to indicate the slot n (or slot m) as a PUCCH slot; or transmit a SR PUCCH in the slot m (or slot n) if there is a positive SR.

In some implementations, the UE transmits the SR PUCCH in the PUCCH slot if there is a positive SR.

In some implementations, the SR in the PCell slot n and the SR in the SCell slot m may be associated with the same or different logical channel IDs.

In some implementations, an invalid PUCCH means that the PUCCH is cancelled due to overlapping with the downlink symbol or the symbol where the SSB is located or the symbol where the CORESET (including CORESET #0) is located. The PUCCH slot is configured based on RRC signaling or is indicated based on DCI signaling.

For Rule 3: the base station configures the SR in the PCell for the UE, and configures the periodic position of the SR in the PCell slot n. The base station configures the SR in the SCell for the UE, and configures the periodic position of the SR in the SCell slot m. If the slot n and the slot m are overlapping in the time domain, and when the PUCCH of the SR configured in the slot n and the slot m are both valid or when the UCI multiplexing is performed in the slot n (or slot m), the multiplexing result PUCCH is valid, then the base station may indicates a slot from the slot n and the slot m as a PUCCH slot; or default the slot n (or slot m) as a PUCCH slot; or expect a SR PUCCH in the PCell (or SCell) to be transmitted in the slot n (or slot m) when there is a positive SR.

In some implementations, the base station expects the SR PUCCH to be transmitted in the PUCCH slot if there is a positive SR. In some implementations, the SR in the PCell slot n and the SR in the SCell slot m may be associated with the same or different logical channel IDs.

In some implementations, the UE is configured with an SR in the PCell and the periodic position of the SR is configured in the PCell slot n. The UE is configured with another SR in the SCell and the periodic position of this SR is configured in the SCell slot m. When the slot n and the slot m are overlapping in the time domain, and when the PUCCH of the SR configured in the slot n and the slot m are both valid or when the UCI multiplexing is performed in the slot n (or slot m), the multiplexing result PUCCH is valid, then UE may: expect to be indicated a slot from the slot n and the slot m as a PUCCH slot; or expect the slot m (or slot n) to be defaulted as a PUCCH slot; or when there is a positive SR, the UE transmits the SR PUCCH in the PCell (or SCell) in the slot n (or slot m).

In some implementations, the UE expects to transmit the SR PUCCH in the PUCCH slot if there is a positive SR. In some implementations, the SR in the PCell slot n and the SR in the SCell slot m may be associated with the same or different logical channel IDs. In some implementations, the valid PUCCH refers to any PUCCH except for the above-mentioned situation corresponding to the invalid PUCCH. In some implementations, the PUCCH slot is configured based on RRC signaling or is indicated based on DCI signaling.

For Rule 4: based on the above described Rule 3, a further condition is added: when the SRs configured in the slot n and the slot m are associated with the same logical channel ID, the base station may: indicate a slot from the slot n and the slot m as a PUCCH slot; or default the slot n (or slot m) as a PUCCH slot; or expect the SR PUCCH in the PCell (or SCell) to be transmitted in the slot n (or slot m) when there is a positive SR.

In some implementations, the base station expects the SR PUCCH to be transmitted in the PUCCH slot if there is a positive SR.

In some implementations, for a UE, based on the above conditions of rule 3, a further condition is added: when the SRs configured in the slot n and the slot m are associated with the same logical channel ID, the UE may: expects to be indicated a slot from the slot n and the slot m as a PUCCH slot; or expect the slot m (or slot n) to be defaulted as a PUCCH slot; or when there is a positive SR, the UE transmits the SR PUCCH in the PCell (or SCell) in the slot n (or slot m).

In some implementations, the UE expects to transmit the SR PUCCH in the PUCCH slot when there is a positive SR.

The present disclosure describes methods, apparatus, and computer-readable medium for wireless communication. The present disclosure addressed the issues with configuring and transmitting a scheduling request (SR). The methods, devices, and computer-readable medium described in the present disclosure may facilitate the performance of wireless communication by configuring and transmitting a SR, thus improving efficiency and overall performance. The methods, devices, and computer-readable medium described in the present disclosure may improves the overall efficiency of the wireless communication systems.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution can be practiced without one or more of the specific features or advantages of a particular embodiment. In other instances, additional features and advantages may be recognized in certain embodiments that may not be present in all embodiments of the present solution.

1. A method for wireless communication, comprising:
determining, by a user equipment (UE) configured with a primary cell (PCell) and a secondary cell (SCell), a first scheduling request (SR) in the PCell, a first logical channel identifier (ID) being associated with the first SR configured in the PCell; and
determining, by the UE, a second SR in the SCell.

2. (canceled)

3. The method according to claim 1, further comprising:
determining, by the UE, a second logical channel ID associated with the second SR configured in the SCell to be same as the first logical channel ID associated with the first SR configured in the PCell.

4. The method according to any of claim 1, wherein:
a physical uplink control channel (PUCCH) for transmitting a SR (SR PUCCH) is configured with a repetition factor N, N being a positive integer; and
in response to the repetition factor N being larger than one, the UE performs PUCCH cell switching between the PCell and the SCell for determining a slot to transmit a next SR PUCCH repetition based on a PUCCH slot pattern by:
in response to the first logical channel ID being associated with a SR configured in a next earliest PUCCH slot indicated by the PUCCH slot pattern, the next earliest PUCCH slot is selected to transmit the next SR PUCCH repetition.

5. The method according to claim 1, wherein:
in response to a SR PUCCH being triggered by the first logical channel ID, the UE performs PUCCH cell switching between the PCell and the SCell for determining a slot to transmit the SR PUCCH based on a PUCCH slot pattern by:
in response to the first logical channel ID being associated with a SR configured in a next earliest PUCCH slot indicated by the PUCCH slot pattern, the next earliest PUCCH slot is selected to transmit the SR PUCCH.

6. The method according to claim 1, wherein:
in response to a next PUCCH slot in the PCell overlapping in a time domain with a next PUCCH slot in the SCell, the next PUCCH slot in the PCell is selected to transmit the next SR PUCCH repetition.

7. The method according to claim 1, wherein:
a SR PUCCH is configured with a repetition factor N, N being a positive integer; and
in response to the repetition factor N being larger than one, the UE perform PUCCH cell switching between the PCell and the SCell for determining a slot to transmit a next SR PUCCH repetition according to at least one of the following:
a PUCCH slot pattern configured between the PCell and SCell,
a PUCCH format of a first SR PUCCH repetition,
a number of symbols of a first SR PUCCH repetition,
an index of a first symbol of a first SR PUCCH repetition,
a period position of SR occasions, or
a logical channel ID associated with a SR.

8. The method according to claim 7, wherein:
the UE determines the slot to transmit the next SR PUCCH repetition according to the PUCCH slot pattern configured between the PCell and SCell, the period position of SR occasions, and the logical channel ID associated with the SR.

9. (canceled)

10. (canceled)

11. The method according to claim 1, wherein:
a first periodic position of the first SR is configured in a PCell slot;
a second periodic position of the second SR is configured in a SCell slot; and
the PCell slot and the SCell slot do not overlap in a time domain.

12. The method according to claim 11, wherein:
a first period of the first SR is same as a second period of the second SR; and
a first offset of the first SR is different as a second offset of the second SR.

13. The method according to claim 1, wherein:
a first periodic position of the first SR is configured in a PCell slot;
a second periodic position of the second SR is configured in a SCell slot;
the PCell slot and the SCell slot overlap in a time domain; and
in response to a SR PUCCH in one of the PCell slot and the SCell slot being invalid or in response to an uplink control information (UCI) multiplexing being performed in one of the PCell slot and the SCell slot and a resulting multiplexing PUCCH including the SR being invalid, one of the following is performed:
not indicating the one of the PCell slot and the SCell slot as a PUCCH slot,
indicating the other of the PCell slot and the SCell slot as a PUCCH slot, or
defaulting the other of the PCell slot and the SCell slot as a PUCCH slot,
wherein the SR PUCCH is transmitted in the PUCCH slot.

14. The method according to claim 13, wherein:
a SR PUCCH is configured with a repetition factor N, N being a positive integer; and
in response to the repetition factor N being larger than one, the UE determines a slot to transmit a next SR PUCCH repetition according to at least one of the following:
determining a slot based on the PUCCH slot pattern to transmit the next SR PUCCH repetition, or
determining the other of the PCell slot and the SCell slot to transmit the next SR PUCCH repetition.

15. The method according to claim 1, wherein:
a first periodic position of the first SR is configured in a PCell slot;
a second periodic position of the second SR is configured in a SCell slot;
the PCell slot and the SCell slot overlap in a time domain;
in response to a SR PUCCH in both of the PCell slot and the SCell slot being valid, one of the following is performed:
indicating one of the PCell slot and the SCell slot as a PUCCH slot, or
defaulting one of the PCell slot and the SCell slot as a PUCCH slot; and
in response to an UCI multiplexing being performed in one of the PCell slot and the SCell slot and a resulting multiplexing PUCCH including the SR being valid, one of the following is performed:
indicating the one of the PCell slot and the SCell slot as a PUCCH slot, or
defaulting the one of the PCell slot and the SCell slot as a PUCCH slot.

16. The method according to claim 15, wherein:
a SR PUCCH is configured with a repetition factor N, N being a positive integer; and
in response to the repetition factor N being larger than one, the UE determines a slot to transmit a next SR PUCCH repetition according to at least one of the following:
determining a slot based on the PUCCH slot pattern to transmit the next SR PUCCH repetition, or
determining the one of the PCell slot and the SCell slot to transmit the next SR PUCCH repetition.

17. The method according to claim 1, wherein:
a first periodic position of the first SR is configured in a PCell slot;
a second periodic position of the second SR is configured in a SCell slot;
the PCell slot and the SCell slot overlap in a time domain;
in response to a SR PUCCH in both of the PCell slot and the SCell slot being valid and being associated with a same logical channel ID, one of the following is performed:
indicating one of the PCell slot and the SCell slot as a PUCCH slot, or
defaulting one of the PCell slot and the SCell slot as a PUCCH slot; and
in response to the SR in both of the PCell slot and the SCell slot being associated with a same logical channel ID, and an UCI multiplexing being performed in one of the PCell slot and the SCell slot and a resulting multiplexing PUCCH including the SR being valid, one of the following is performed:
indicating the one of the PCell slot and the SCell slot as a PUCCH slot, or
defaulting the one of the PCell slot and the SCell slot as a PUCCH slot.

18. The method according to claim 17, wherein:
a SR PUCCH is configured with a repetition factor N, N being a positive integer; and
in response to the repetition factor N being larger than one, the UE determines a slot to transmit a next SR PUCCH repetition according to at least one of the following:
determining a slot based on the PUCCH slot pattern to transmit the next SR PUCCH repetition, or
determining the one of the PCell slot and the SCell slot to transmit the next SR PUCCH repetition.

19. (canceled)

20. (canceled)

21. An apparatus comprising:
a memory storing instructions; and
a processor in communication with the memory, wherein, when the processor executes the instructions, the processor is configured to cause the apparatus configured with a primary cell (PCell) and a secondary cell (SCell) to perform:
determining a first scheduling request (SR) in the PCell, a first logical channel identifier (ID) being associated with the first SR configured in the PCell; and
determining a second SR in the SCell.

22. The apparatus according to claim 21, wherein, when the processor executes the instructions, the processor is configured to further cause the apparatus to perform:
determining a second logical channel ID associated with the second SR configured in the SCell to be same as the first logical channel ID associated with the first SR configured in the PCell.

23. The apparatus according to claim 21, wherein:
a physical uplink control channel (PUCCH) for transmitting a SR (SR PUCCH) is configured with a repetition factor N, N being a positive integer; and
in response to the repetition factor N being larger than one, the apparatus performs PUCCH cell switching between the PCell and the SCell for determining a slot to transmit a next SR PUCCH repetition based on a PUCCH slot pattern by:
in response to the first logical channel ID being associated with a SR configured in a next earliest PUCCH slot indicated by the PUCCH slot pattern, the next earliest PUCCH slot is selected to transmit the next SR PUCCH repetition.

24. A non-transitory computer program product comprising a computer-readable program medium storing instructions, wherein, the instructions, when executed by a processor of an apparatus configured with a primary cell (PCell) and a secondary cell (SCell), are configured to cause the processor to perform:
determining a first scheduling request (SR) in the PCell, a first logical channel identifier (ID) being associated with the first SR configured in the PCell; and
determining a second SR in the SCell.

25. The non-transitory computer program product according to claim 24, wherein the instructions, when executed by the processor, are configured to further cause the processor to perform:
determining a second logical channel ID associated with the second SR configured in the SCell to be same as the first logical channel ID associated with the first SR configured in the PCell.
